(19) United States
(12) Patent Application Publication
(10) Pub. No.: US 2008/0219746 A1
(43) Pub. Date: Sep. 11, 2008

(54) Pen with bent tip

(76) Inventors: Sun Joo Lee, Santa Monica, CA (US); Chun Sik Ham, La Mirada, CA (US)

Correspondence Address: Sun Joo Lee, 1134 11th St. # 201, Santa Monica, CA, 90403, US

(21) Appl. No.: 11/732,227

(22) Filed: Apr. 2, 2007

(30) Foreign Application Priority Data
Mar. 8, 2007 (KR) 10-2007-0023048

(51) Int. Cl. A46B 5/02; B43K 7/10

(52) U.S. Cl. 401/6; 401/216

(57) ABSTRACT

Disclosed therein is a writing pen with a rotation-preventing bent tip. The writing pen includes a rotation-preventing bent tip and a tip housing which are coupled to each other in a key-locking type to prevent a rotation of the tip or the tip housing by a pressing force generated when a user writes down. The tip 1 has a rotation-preventing protrusion 1b, the tip housing 2 has a rotation-preventing protrusion 2b and a groove 2c to which the protrusion 1b is coupled, and a main housing 3 has a groove 3c to which the protrusion 2b is coupled, so that the tip 1, the tip housing 2 and the main housing 3 are coupled to one another in the key-locking type to thereby provide a mutual interrupting action. So, even though a great force is applied to the writing pen when a user writes down, the tip 1 is not rotated, so that the user can use it freely and comfortably without regard to a used angle of the writing pen.

### BACKGROUND OF THE INVENTION

1. Field of the Invention

The present invention relates to a writing pen with a bent tip which has a plurality of components, and more particularly, to a writing pen with a bent tip prevented in rotation.

2. Background Art

Korean Utility Model Publication No. 20-174278 discloses a writing pen, which has a front end part bent at a proper angle according to a user's grasping angle, and whose a front end of a refill combined inside an outer casing is worn in balance. In Korean Utility Model Publication No. 20-174278, the writing pen, in which the refill having a cylindrical tube for charging ink therein and a metallic ball bearing mounted on the front end thereof is combined inside the tubular outer casing, or, which has a pen point for writing, includes a grasping part formed on the front end of the outer casing of the writing pen and bent to keep a predetermined angle in one direction or the pen point inwardly bent at a predetermined angle.

In Korean Utility Model Publication No. 20-174278 (hereinafter, called ‘cited reference’), the front end of the writing pen, namely, the lower end of the grasping part formed on the outer casing of the writing pen is bent to keep a predetermined angle in one direction, and in this instance, the bending angle is an angle inclined as much as the refill combined inside the writing pen is not completely bent but inclined somewhat. Preferably, the bending angle is about 10° to 20°.

In claim 1 of the above cited reference, the writing pen, in which the refill having a cylindrical tube for charging ink therein and a metallic ball bearing mounted on the front end thereof is combined inside the tubular outer casing, or, which has a pen point for writing, is characterized in that a grasping part formed on the front end of the outer casing of the writing pen is bent to keep a predetermined angle in one direction. In claim 2 of the above cited reference, the writing pen according to claim 1 is characterized in that the pen point is inwardly bent at a predetermined angle. In claim 3 of the above cited reference, the writing pen according to claims 1 and 2 is characterized in that a bending angle of the writing pen and the pen point is about 10° to 20°.

In the cited reference, the front end of the writing pen, namely, the lower end of the grasping part formed on the outer casing of the writing pen is bent to keep a predetermined angle in one direction, and in this instance, the bending angle is an angle inclined as much as the refill combined inside the writing pen is not completely bent but inclined somewhat, preferably, 10° to 20°. However, the writing pen cannot provide users with good efficiency as a bent writing pen.

In other words, writing pens must be generally and widely used without regard to distinction of sex and distinction of age, but the writing pen of the cited reference has been invented without regard to the user's writing posture and writing habit and a value of commodity.

Judged from the above view point, the cited reference, which has the front end, namely, the lower end of the grasping part formed on the outer casing, is bent at a predetermined angle in one direction, does not consider that most of users use the writing pen while holding the lowest location of the writing pen, namely, the lower end portion of the outer casing, with the thumb, the index finger and the middle finger. In addition, the cited reference does not consider technical matters related with manufacturing process and method. So, the cited reference has no practical value, and is unmarketable.

In general, most of people writes something while holding the lowest location of the writing pen with three fingers, and writes down while checking their styles of penmanship in a state where ends of the fingers approach the paper surface the nearest and they bend themselves forward.

However, considering that the lower end portion of the outer casing, namely, a hand-grip of the writing pen, is bent, since the lowest location of the writing pen, namely, a narrow tube portion where the outer casing starts to become narrow, cannot be bent, a portion above the narrow tube portion of the writing pen is inevitably bent, and so, the user cannot grasp the lowest portion of the writing pen with the fingers but has to grasp the portion located at a predetermined height.

Therefore, when the user uses the writing pen according to the cited reference, since the user cannot write down in a stable posture that the hand grasping the writing pen is in contact with the paper surface, the user's hand is shaken, and so, the user cannot obtain a good style of penmanship.

When the user writes down for a long time in the above state, the user may feel a great fatigue since the user sets his or her nerves on writing and consumes energy. In addition, if the above state is continued, many students who are in a growth period and many office workers who have to use the writing pens for a long time vocationally suffer from a phenomenon of bent vertebrae.

Furthermore, the cited reference does not consider manufacturing process and method. The writing pen according to the cited reference cannot be made with a double-sided slide mold of a relatively good efficiency, and is difficult to be injection-molded. So, even though the writing pens of the above structure can be manufactured and supplied to consumers, since they cannot be supplied to the consumers in an inexpensive price which the consumers want, the cited reference is an invention which has no practical value in fact.

In the meantime, U.S. Pat. No. 2,487,340 discloses a revolvable-ball-point pen, whose an end portion is inclined from a penholder at a predetermined angle. However, in aspects of its technology and structure, the revolvable-ball-point pen has a structure that a ball is coupled to a nib of a fountain pen, and so, the cited reference is entirely different from the present invention.

Moreover, U.S. Pat. No. 2,592,406 discloses a fountain pen of the ball point type. In U.S. Pat. No. 2,592,406, a ball cavity of a ball housing provided in the outer end of a pen tip is formed eccentrically, and then, a ball is coupled with the ball cavity. The fountain pen also provides an inclination angle, but an object of the above cited reference is to provide the fountain pen of the ball point type and a technical background of the above cited reference is that the ball cavity is formed eccentrically and the ball is coupled to the ball cavity. So, also the above cited reference is different from the present invention in connection with the object and technology.

In addition, U.S. Pat. No. 3,032,012 discloses a retractable ball point pen, and U.S. Pat. No. 3,281,993 discloses a method for an inclined pen point. The above cited references also provide a predetermined inclination angle. However, since the cited references also have a structure that a ball cavity is formed eccentrically in a ball housing and a ball is coupled with the ball cavity, the above cited references are considerably different from the present invention in connection with the object and components.

Additionally, U.S. Pat. No. 5,012,663 discloses a method of bending a ball point pen tip, which has a bellows portion formed on a portion of a ball housing so that the bellows portion is bent or stretched according to a force applied to the pen. However, the above cited reference is also different from the present invention in connection with the object and technical construction.

Moreover, U.S. Pat. No. 6,039,493 discloses a ball point pen, which has a nib member formed inclinedly at an end of a housing body, wherein a ball is located at a longitudinally central portion of the straight body of the writing pen. So, the above cited reference is also entirely different from the present invention.

### SUMMARY OF THE INVENTION

Accordingly, the present invention has been made in an effort to solve the above-mentioned problems occurring in the prior arts, and it is an object of the present invention to provide a writing pen with a rotation-preventing bent tip, which has a structure allowing a user to write down in the most stable and comfortable posture.

It is another object of the present invention to provide a writing pen with a rotation-preventing bent tip, which can effectively prevent vertebral troubles and a shoulder-inclination-symptom frequently caused to students, literary writers and pen character artists who seat and write down for a long time, and gradually correct such troubles and symptom while the user uses it.

It is a further object of the present invention to provide a writing pen with a bent rotation-preventing tip, which can be easily manufactured through a simple manufacturing process.

To accomplish the above object, according to the present invention, there is provided a writing pen with a rotation-preventing bent tip, which has a bent portion formed at a central portion of the tip coupled to an end of a tip housing and a rotation-preventing protrusion formed at an end thereof, the bending angle being 50°±5°, whereby a user can write down in the most stable and comfortable posture.

In addition, the tip housing to which the tip is inserted and fit includes a groove formed on the inner peripheral surface of a tip introduction hole thereof to thereby fittingly couple the rotation-preventing protrusion to the groove.

Furthermore, a main housing to which the tip housing is inserted and fit includes a groove formed on the inner peripheral surface of a housing introduction hole thereof to thereby fittingly couple the tip housing to the groove.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a writing pen according to a first preferred embodiment of the present invention;

FIG. 2 is a cross sectional view of the writing pen of FIG. 1;

FIG. 3 is a perspective view of a bent tip, a tip housing and a main housing of the writing pen;

FIG. 4 is an enlarged perspective view for explaining essential components of FIG. 1;

FIG. 5 is an enlarged sectional view showing an assembled state of FIG. 4;

FIG. 6 is a partially sectional view taken along the line of A-A of FIG. 5, showing a state where the tip, the tip housing and the main housing are interrupted to one another in rotation;

FIG. 7 is an exploded perspective view of a writing pen according to a second preferred embodiment of the present invention;

FIG. 8 is an enlarged perspective view of the front part of a main housing of FIG. 7;

FIG. 9 is a perspective view showing an assembled state of the writing pen of FIG. 7;

FIG. 10 is a perspective view showing a tip and a tip housing of the writing pen of FIG. 9;

FIG. 11 is a cross sectional view for explaining a writing pen structure of FIG. 9;

FIG. 12 is an enlarged sectional view of essential parts of FIG. 9;

FIG. 13 is a perspective view of the tip and the tip housing shown in FIG. 12;

FIG. 14 is a cross sectional view for explaining the inner structure of the tip housing of FIG. 13;

FIG. 15 is a perspective view of a tip and a tip housing of a writing pen according to a third preferred embodiment of the present invention;

FIG. 16 is a cross sectional view for explaining the inner structure of the tip housing of FIG. 15;

FIG. 17 is a perspective view of a tip and a tip housing of a writing pen according to a fourth preferred embodiment of the present invention;

FIG. 18 is a cross sectional view for explaining the inner structure of the tip housing of FIG. 17;

FIG. 19 is a perspective view of a tip and a tip housing of a writing pen according to a fifth preferred embodiment of the present invention; and

FIG. 20 is a cross sectional view for explaining the inner structure of the tip housing of FIG. 19.

### DETAILED DESCRIPTION OF THE PREFERRED EMBODIMENT

Reference will be now made in detail to the preferred embodiment of the present invention with reference to the attached drawings. The same parts have the same reference numerals in drawings.

A first preferred embodiment of the present invention will be described.

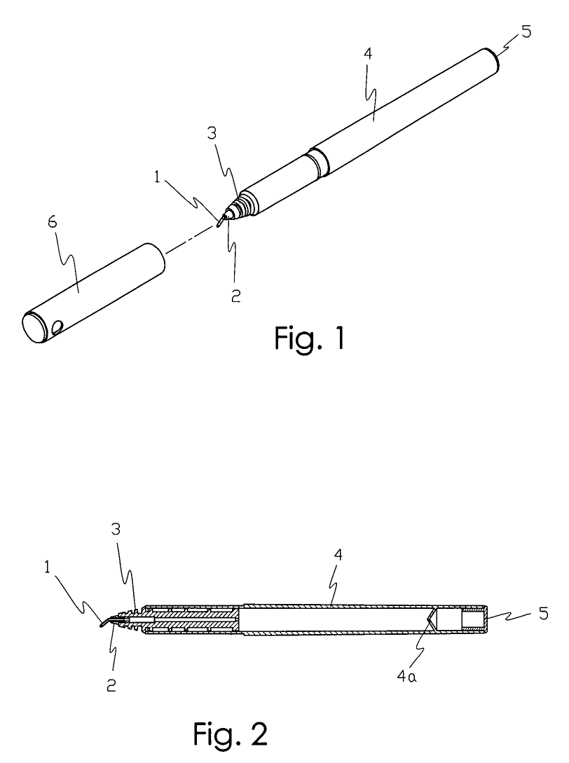

According to the first preferred embodiment illustrated in FIG. 1, a tip 1 is made of tungsten, stainless steel or the like metallic material. The tip 1 is manufactured by a bending method, a cold expansion method or others, and fittingly coupled to a tip housing 2.

In this instance, the tip 1 includes: a bent portion la having an end, to which a ball is inserted, and bent at its central portion at an angle of 50°±5°; and a rotation-preventing protrusion 1b protrudingly formed on the outer peripheral surface of a straight tubular body thereof in a longitudinal direction.

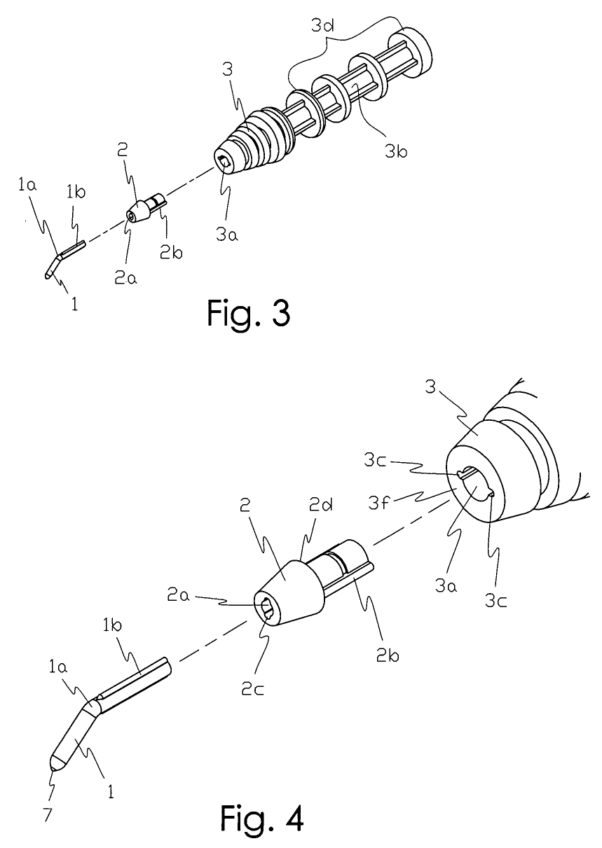

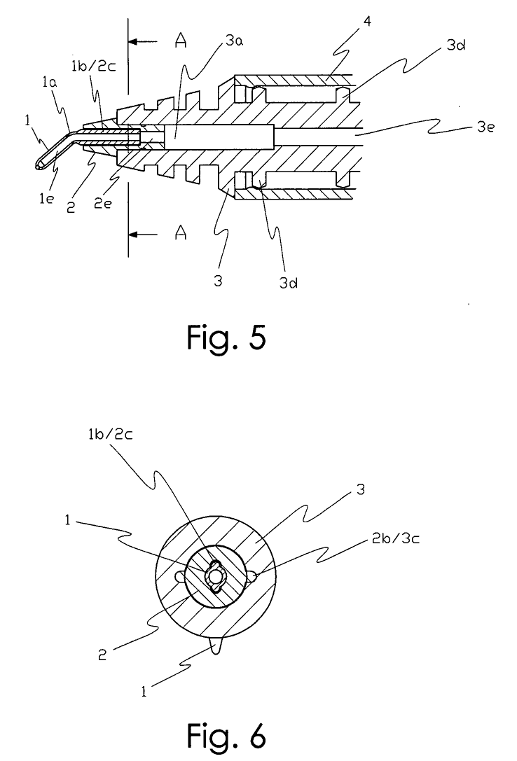

The tip housing 2, to which the other end of the tip 1 is coupled, is made of synthetic resin and injection-molded. The tip housing 2 has an end portion to which the tip 1 is fittingly coupled, and the other end portion fittingly coupled to a main housing 3 as shown in FIGS. 2 to 5.

The tip housing 2 is formed in an arrowhead shape, and includes: a tip introduction hole 2a to which the tip 1 is fittingly coupled; a rotation-preventing protrusion 2b protrudingly formed on the outer peripheral surface of the tip housing 2 in a longitudinal direction; and a key-slot-type groove 2c formed on the inner wall surface of the tip introduction hole 2a fit to the main housing 3 in a longitudinal direction, wherein the rotation-preventing protrusion 1b is inserted and fit to the key-slot-type groove 2c and the rotation-preventing protrusion 2b is fit to a groove 3c of the main housing 3 for a mutual interrupting action.

In addition, the main housing 3 to which the tip housing 2 is fit includes a contact surface 3f formed on the front face thereof, the groove 3c longitudinally formed on the inner wall surface of the housing introduction hole 3a. The groove 3c is a key-slot-type and the rotation-preventing protrusion 2b is fittingly coupled to the groove 3c.

In the meantime, an ink supply refill is coupled to an ink passage 1e of the tip 1 and an ink passage 2e of the tip housing 2 so as to receive ink from the main housing 3. The main housing 3 is coupled to an ink reservoir tube 4, which has a shielding plate 4a formed by shielding the inner side of a tubular body thereof, to receive ink.

The ink reservoir tube 4 is so-called a penholder or a pen-handle. A liquid-type ink is stored in a hollow of the ink reservoir tube 4, so that ink is supplied to the tip 1 while and ink pressure is controlled in the tip housing 3 whenever a user writes down using this pen.

The order for assembling the above components and the operational effects of the writing pen according to the present invention will be described in detail as follows.

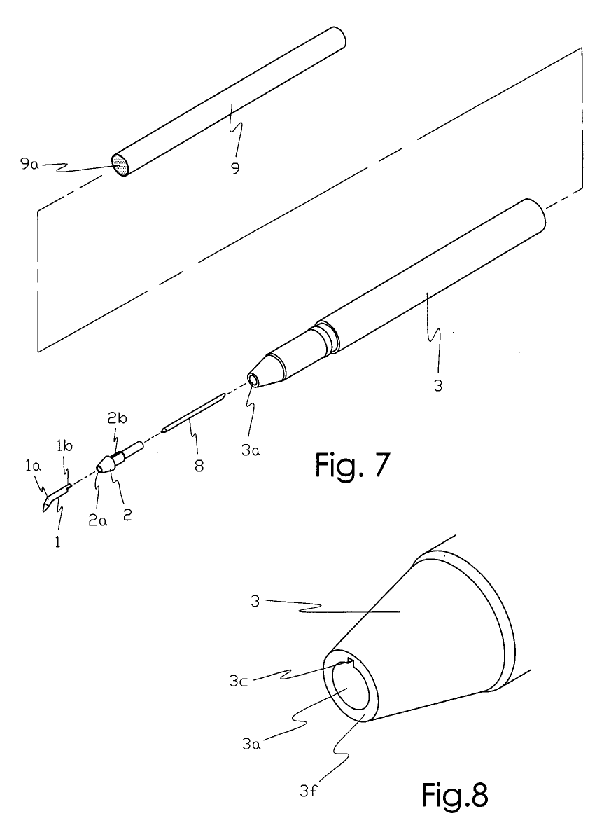

The ink supply refill 8 shown in FIG. 7 is inserted into the tubular body of the tip 1 having the rotation-preventing protrusion 1b, and then, an end of the refill 8, which protrudes outwardly from the tip 1, is inserted into the tip introduction hole 2a of the tip housing 2.

In this instance, in a state where the rotation-preventing protrusion 1b is coincided with the groove 3c formed on the tip introduction hole 2a of the tip housing 2, the tip 1 is deeply pushed to a position where the bent portion 1a thereof arrives at the front end of the tip introduction hole 2a to combine the tip 1 with the tip housing 2.

Next, in the same manner as that the tip 1 is coupled to the tip housing 2, the tip housing 2 to which the tip 1 is coupled is coupled to the main housing 3 in such a manner that the rotation-preventing protrusion 2b of the tip housing 2 is coincided with the groove 3c formed on the housing introduction hole 3a of the main housing 3 and pushed till a perpendicularly stepped jaw 2d of the tip housing 2 is in contact with the contact surface 3f of the main housing 3.

In a state where the tip 1, the tip housing 2 and the main housing 3 are coupled to each other as one structure, a sealing ring 3d of the main housing 3 is fit to the ink reservoir tube 4 which restores ink.

In this instance, since the ink reservoir tube 4 is made of synthetic resin material which is somewhat soft but the sealing ring 3d of the main housing 3 is highly rigid and has the outer diameter larger than a diameter of the ink reservoir tube 4, the sealing ring 3d is forcedly fit to the ink reservoir tube 4.

Therefore, the ink contained in the ink reservoir tube 4 is not leaked to the outside, and is transferred to the tip 1 through the ink passage 3e of the main housing 3 and the ink passage 2e of the tip housing 2 to allow the user's writing. When the user writes down using the writing pen according to the present invention, in the same way as generally-known writing pens, the user can grasp the writing pen and write down in the most comfortable posture according to the user's taste or habit.

In case of using the generally-known writing pens, the user can write down normally when the user holds the writing pen at an angle of 75° to 85°, but in case of using the writing pen according to present invention, the user can write down at a low angle of 45° to 50°.

Meantime, the writing pens according to the cited references can be used at the low angle like the present invention, but since the user cannot locate his or her hand at the lowest position of the writing pen, the user's hand is not located the closest to the paper surface while writing. So, since the user's hand cannot be supported on the paper surface, the user cannot write down in a stable posture, and so, has to correct a style of penmanship or learn a new writing posture.

However, since the writing pen according to the present invention has the bent tip located at the end of the writing pen without bending of the tip housing or the main housing, the user can grasp the writing pen at the lowest position of the writing pen and write down in a state where the hand grasping the writing pen is located the closest to the paper surface, so that the user can obtain the best style of penmanship in the stable posture.

Since the tip, the tip housing and the main housing have the rotation-preventing protrusions and grooves for the mutual interruption, the user can use the writing pen comfortably in a state where the bent tip stands, and particularly, in a state where the bent tip is directed sidewards.

So, when the user writes down while the bent tip is directed in the inward direction of the hand grasping the writing pen, since the bent tip is not idly rotated from the tip housing even though the user applies a force to the writing pen due to his or her writing habit, the user can correct his or her bad style of penmanship and writing posture while checking his or her writing posture. In addition, the user can obtain a wanted style of penmanship and a wanted picture since the user can freely use his or her hand from a narrow reciprocating motion to a wide reciprocating motion while writing down using the writing pen.

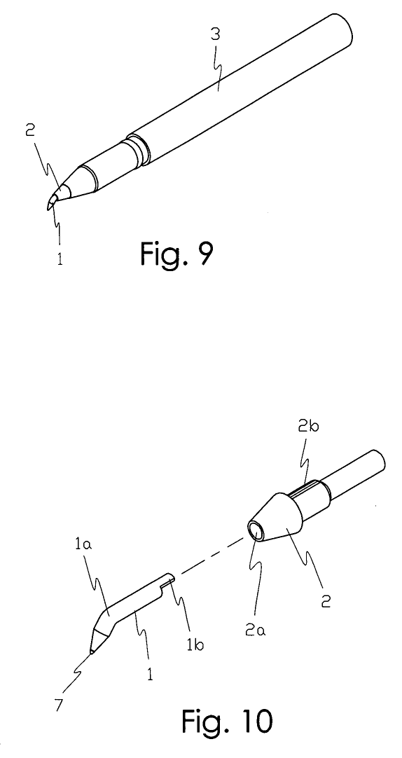

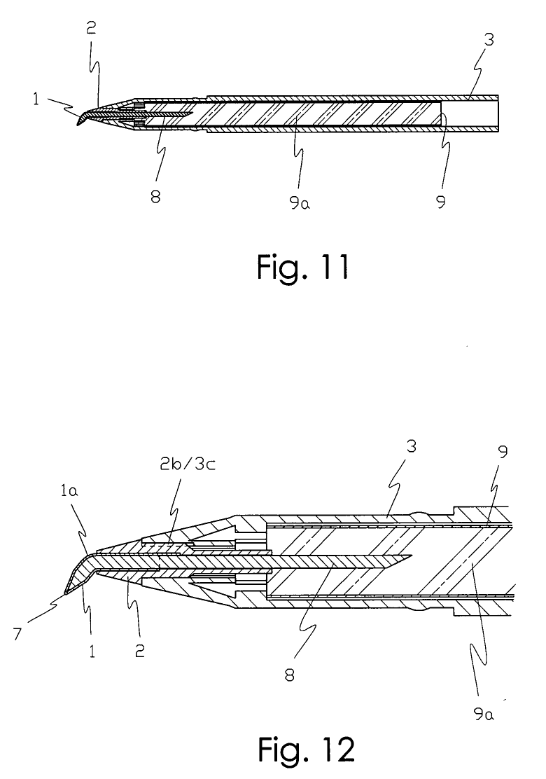

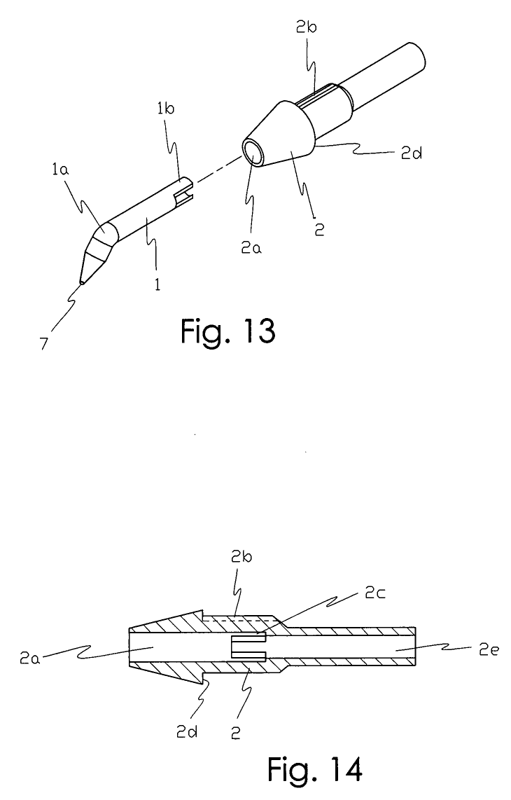

Meanwhile, referring to FIGS. 7 to 14, a second preferred embodiment of the present invention will be described as follows. As shown in FIGS. 7 to 14, the tip 1 has a wing-like rotation-preventing protrusion 1b formed at an end thereof, and as shown in FIG. 14, the tip housing 2 has a fault-shaped groove 2c formed in the ink passage 2e of the tip housing 2 to which the rotation-preventing protrusion 1b is fit. The wing-like rotation-preventing protrusion 1b and the fault-shaped groove 2c may be formed at two points where two rotation-preventing protrusions 1b and two fault-shaped grooves 2c are coupled to each other or at three points where three rotation-preventing protrusions 1b and three fault-shaped grooves 2c are coupled to each other.

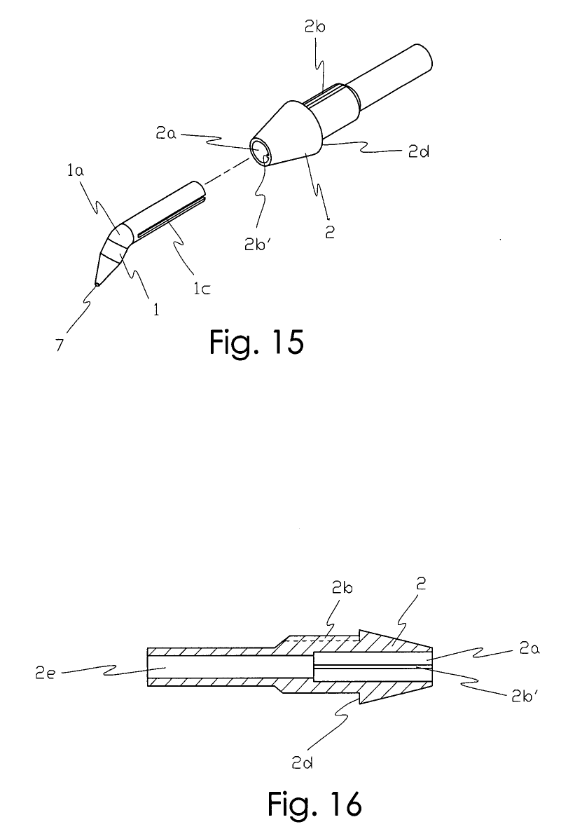

As a third preferred embodiment of the present invention, as shown in FIGS. 15 and 16, the tip 1 has one or two elongated groove 1c longitudinally formed on one or two sides of the tubular body thereof, and the tip housing 2 has one or two rotation-preventing protrusion 2b′ longitudinally formed on the tip introduction hole 2a so that the elongated groove 1c is fittingly coupled to the rotation-preventing protrusion 2b′ for a key-locking action, whereby the tip 1 is not rotation out from the tip housing 2.

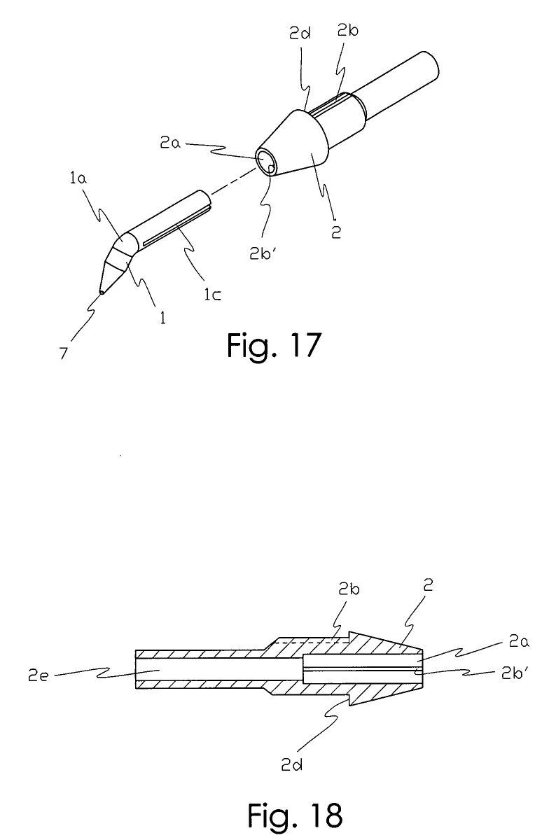

In addition, a fourth preferred embodiment of the present invention will be described. As shown in FIGS. 17 and 18, the tip 1 has one, two or three U-shaped or V-shaped groove 1c longitudinally formed on the tubular body thereof, and the tip housing 2 coupled to the tip 1 has one, two or three rotation-preventing protrusion 2b′ formed correspondingly to the groove 1c, whereby the tip 1 is not rotated in a state where the tip 1 is coupled to the tip housing 2.

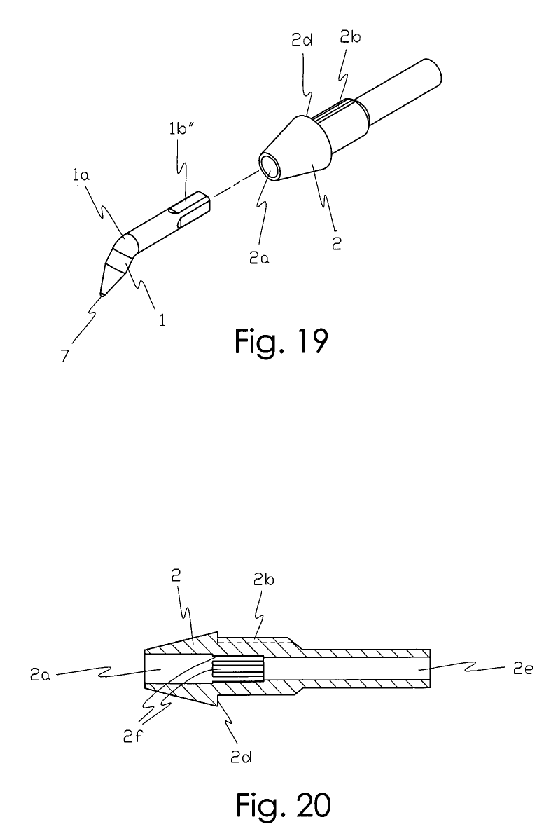

Furthermore, a fifth preferred embodiment of the present invention will be described. As shown in FIGS. 19 and 20, the tip 1 has a rectangular rotation-preventing surface 1b″ formed on an end portion of the tubular body thereof by partially cutting the end portion thereof, and the tip housing 2 has a socket-type rotation-preventing restriction surface 2f formed on the inner peripheral surface of the tip introduction hole 2a thereof correspondingly to the rotation-preventing surface 1b″, so that the rotation-preventing surface 1b″ is coupled to the rotation-interrupting surface 2f when the rotation-preventing surface 1b″ of the tip 1 is inserted and fit to the tip introduction hole 2a of the tip housing 2 to thereby keep the coupled state of the tip 1 without rotation even though the user tries to forcedly rotate the tip 1.

In addition, the writing pen according to the present invention can effectively prevent vertebral troubles and a shoulder-inclination-symptom frequently caused to students, literary writers and pen character artists who seat and write down for a long time, and gradually correct such troubles and symptom while the user uses it.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A writing pen with a rotation-preventing bent tip, which includes various components, comprising:
a tip having a bent portion bent at a predetermined angle in one direction and a rotation-preventing protrusion protrudingly formed on the outer peripheral surface of a straight tubular portion thereof;
a tip housing to which the tip is fittingly coupled, the tip housing having a tip introduction hole formed therein for allowing the tip to be inserted and fit thereto, and a key-slot type groove and a rotation-preventing protrusion formed on an outer peripheral surface of a part thereof; and
a main housing to which the tip housing is inserted and fit, the main housing having a groove formed on a housing introduction hole thereof formed therein,
whereby the tip is prevented from being idle or rotating in the writing pen.

2. The writing pen according to claim 1, comprising:
a tip having a bent portion bent at a predetermined angle in one direction and a rotation-preventing protrusion protrudingly formed on the outer peripheral surface of a straight tubular portion thereof; and
a tip housing to which the tip is fittingly coupled, the tip housing having a tip introduction hole formed therein for allowing the tip to be inserted and fit thereto, and a key-slot type groove and a rotation-preventing protrusion formed on an outer peripheral surface of a part thereof,
whereby the tip is prevented from being idle or rotating in the writing pen.

3. The writing pen according to claim 1, comprising:
a tip having a bent portion bent at a predetermined angle in one direction and one or two wing-like rotation-preventing protrusion formed at an end of a straight tubular portion thereof along a cylindrical surface thereof;
a tip housing to which the tip is fittingly coupled, the tip housing having a tip introduction hole formed therein for allowing the tip to be inserted and fit thereto, a key-slot type groove formed on the inner peripheral surface of a tip introduction hole to which the tip is inserted and fit, the wing-like rotation-preventing protrusion being fittingly coupled to the groove; and
a main housing to which the tip housing is inserted and fit, the main housing having a groove formed on a housing introduction hole thereof formed therein,
whereby the tip is prevented from being idle or rotating in the writing pen.

4. The writing pen according to claim 1, comprising:
a tip having a bent portion bent at a predetermined angle in one direction and one or two wing-like rotation-preventing protrusion formed at an end of a straight tubular portion thereof along a cylindrical surface thereof; and
a tip housing to which the tip is fittingly coupled, the tip housing having a tip introduction hole formed therein for allowing the tip to be inserted and fit thereto, a key-slot type groove formed on the inner peripheral surface of a tip introduction hole to which the tip is inserted and fit, the wing-like rotation-preventing protrusion being fittingly coupled to the groove,
whereby the tip does not idle or rotate in the writing pen.

5. The writing pen according to claim 1, wherein the rotation-preventing protrusion is formed at one or two sides of the tubular body of the tip, and the groove is formed on the tip introduction hole of the tip housing, whereby the tip and the tip housing are prevented from rotating by a key-locking action.
